(19) United States
(12) Patent Application Publication
(10) Pub. No.: US 2007/0044479 A1
(43) Pub. Date: Mar. 1, 2007

(54) Hydrogen production from an oxyfuel combustor

(76) Inventors: Harry Brandt, El Macero, CA (US); Muriel R. Brandt, (US); Roger E. Anderson, Gold River, CA (US); Keith L. Pronske, Wilton, CA (US); Fermin Viteri, Sacramento, CA (US); Scott MacAdam, El Dorado Hills, CA (US)

Correspondence Address: BRADLEY P. HEISLER;HEISLER & ASSOCIATES, 3017 DOUGLAS BOULEVARD, SUTIE 300, ROSEVILLE, CA, 95661, US

(21) Appl. No.: 11/502,209

(22) Filed: Aug. 10, 2006

Related U.S. Application Data
(60) Provisional application No. 60/707,326, filed on Aug. 10, 2005.

(51) Int. Cl. F02C 6/00

(52) U.S. Cl. 60/783; 60/784

(57) ABSTRACT

A system is provided for hydrogen production from a hydrogen and carbon containing fuel combusted within an oxyfuel combustor. The oxyfuel combustor combusts hydrogen and carbon containing fuel with oxygen at a non-stoichiometric ratio, typically fuel rich. In such an operating mode, products of combustion include steam, carbon dioxide, carbon monoxide and hydrogen. These products of combustion are then passed through a hydrogen separator where hydrogen is separated. Remaining products of combustion can be optionally combusted at a stoichiometric ratio with oxygen in a second oxyfuel combustor discharging substantially only steam and carbon dioxide. A turbine can be provided downstream from the gas generator to produce power and eliminate carbon monoxide from the system. The system can be operated in a second mode where the gas generator combusts the fuel with oxygen at a stoichiometric ratio to maximize electric power generation without hydrogen production at periods of peak electric power demand.

### CROSS-REFERENCE TO RELATED APPLICATIONS

This application claims benefit under Title 35, United States Code §119(e) of U.S. Provisional Application No. 60/707,326 filed on Aug. 10, 2005.

### FIELD OF THE INVENTION

The following invention relates to combustion based power generation systems and particularly those which can also produce hydrogen. More particularly, this invention relates to power generation systems which combust oxygen and a hydrogen and carbon containing fuel in a gas generator which operates fuel rich to leave hydrogen separate from water within the products of combustion, and which further include a separator to separate the hydrogen from other products of combustion.

### BACKGROUND OF THE INVENTION

Long range energy planners are placing increasing importance on the utilization of hydrogen as a power generating fuel, due to the pollution minimizing characteristics (and particularly avoidance of greenhouse gas emissions such as carbon dioxide) associated with such hydrogen utilization. One challenge faced for widespread hydrogen utilization is the lack of low cost high volume convenient sources of hydrogen. It is known in the prior art to generate electric power from coal through utilization of an integrated gasification combined cycle (IGCC) with the addition of hydrogen separation technology to separate hydrogen from the syngas fuel before remaining constituents of the syngas fuel are combusted, for instance at the Sarlux plant in Italy. One obvious drawback of such a system for generating hydrogen is that the remaining hydrogen depleted syngas still generates significant pollution, and especially carbon dioxide and oxides of nitrogen when combusted with air and expanded to generate electric power. Thus, while hydrogen is produced for the benefit of the environment, such systems correspondingly also emit greenhouse gases and other pollutants, undermining the very purpose for which the hydrogen is originally being produced.

Other techniques for hydrogen production include electrolysis where an electric current is applied to water, separating the water into hydrogen gas and oxygen gas. However, electrolysis is currently prohibitively expensive in that it requires a significant electric current to achieve electrolysis. Hence, electrolysis systems today are not economical for large scale hydrogen production.

When hydrogen is in a mixture with other molecules, the rather small size of the hydrogen molecule (H2) makes it suitable for membrane separation from other gases in the mixture. For instance, U.S. Pat. No. 6,761,929 describes in detail a membrane and membrane manufacturing method suitable for hydrogen separation. This patent is incorporated herein by reference in its entirety.

Other hydrogen separation techniques include pressure swing adsorption systems such as those provided by Air Products and Chemicals, Inc. of Allentown, Pa. and described in detail in U.S. Pat. No. 6,660,064. This patent is incorporated herein by reference in its entirety.

### SUMMARY OF THE INVENTION

An oxyfuel combustor such as the gas generator described herein is modified to produce hydrogen from combustion of a hydrogen containing fuel with oxygen. Specifically, rather than burning a stoichiometric ratio of methane or other hydrogen and carbon containing fuel (including syngas) with oxygen, excess fuel is provided. Hence, the fuel is only partially combusted with one of the combustion products being hydrogen, and other combustion products typically being carbon monoxide, carbon dioxide and water. With this gas generator, water is also typically introduced into the combustion chamber. The resulting combustion products are then passed to a hydrogen separator which is capable of removing the hydrogen from other products of combustion.

Most preferably, this separator receives the combustion products at optimal temperatures and pressures for optimal use of the hydrogen separating technology involved. If the temperature and/or pressure benefits from being reduced before separation, a turbine is interposed between the gas generator and the separator to both output power and reduce the temperature and/or pressure of the combustion products. The separator technology, membrane technology, pressure swing adsorption technology or other separation technologies known in the art for separation of the hydrogen.

The separated hydrogen can be used for various purposes, such as powering fuel cells, powering hydrogen fueled vehicles or other equipment or engines, or otherwise supplying hydrogen to the industrial gas market or for other beneficial uses. Downstream from the separator, the remaining combustion products are typically carbon monoxide, carbon dioxide and water, with typically some hydrogen remaining with these other combustion products. These remaining combustion products can be further processed in a variety of different ways. Most preferably, to both capture the carbon dioxide, generate additional power, and supply a clean source of water for recirculation to the gas generator, some form of combustor is fed with this stream discharged from the hydrogen separator. In particular, a second oxyfuel gas generator similar to the first gas generator described above can be utilized, with these remaining combustion products provided as the fuel for this gas generator. If necessary, additional fuel such as methane can be added.

This second gas generator would also receive oxygen and typically additional water for proper functioning of the gas generator. The ratio of fuel to oxygen in this second gas generator would preferably be selected for complete combustion of the carbon monoxide and oxygen, as well as any introduced fuel and excess hydrogen, such that the only constituents in the combustion products exiting this second gas generator are steam and carbon dioxide. This steam and carbon dioxide mixture can then be handled in a manner similar to the power generation systems described elsewhere in this disclosure.

In one typical simplified system, the steam and carbon dioxide would feed a turbine which drives an electric generator. The reduced pressure and reduced temperature mixture of steam and carbon dioxide would then be passed to a separator, such as a condenser, where the CO2 would either be captured for commercial sale or for sequestration or enhanced oil recovery, enhanced coal bed methane recovery, or other beneficial use for the CO2. The water separated from the CO2 would be available for recirculation to the first gas generator and/or the second gas generator. In more complex variations of this system, additional reheaters and additional turbines could also be added. Also, the recirculated water could be preheated, such as with feed water heaters that would tap off heat from somewhere between the first gas generator and the condenser. The water would thus be preheated before being returned to one of the gas generators to enhance the efficiency of the overall system. The oxygen can be supplied from various different sources including from an air separation unit which could operate by liquefying air to separate oxygen from other constituents in the air, or can utilize ion transport membranes (ITM) or other oxygen producing or air separating technology.

### OBJECTS OF THE INVENTION

Accordingly, a primary object of the present invention is to provide a method for hydrogen production through combustion of a hydrogen containing fuel with oxygen.

Another object of the present invention is to provide a method and system for large scale hydrogen production.

Another object of the present invention is to provide a method and system for low cost hydrogen production.

Another object of the present invention is to provide a system for simultaneously producing hydrogen and generating power without atmospheric emissions.

Another object of the present invention is to provide a hydrogen production and power generation system utilizing hydrogen and energy stored within a hydrocarbon fuel or other hydrogen containing fuel without atmospheric emissions.

Another object of the present invention is to provide a power generation system for low cost high volume production of hydrogen as well as some electric power when electric power demand is low and a greater amount of electric power when electric power demand is high.

Other further objects of the present invention will become apparent from a careful reading of the included drawing figures, the claims and detailed description of the invention.

### BRIEF DESCRIPTION OF THE DRAWINGS

FIG. 1 is a schematic of a basic oxyfuel combustion hydrogen production system according to one embodiment of this invention.

FIG. 2 is a schematic of an oxyfuel combustion power generation system featuring hydrogen separation and electric power generation capable of zero atmospheric emissions.

### DESCRIPTION OF THE PREFERRED EMBODIMENT

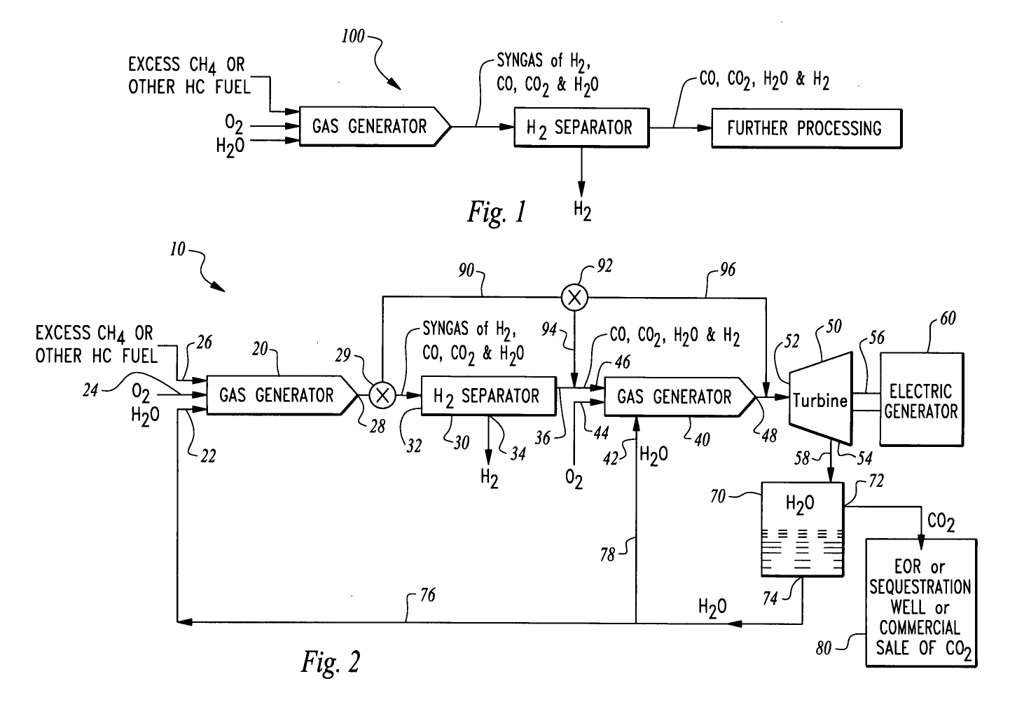

Referring to the drawings, wherein like reference numerals represent like parts throughout the various drawing figures, reference numeral 10 (FIG. 2) and reference numeral 100 (FIG. 1) are directed to systems for generation and separation of hydrogen from a hydrogen containing fuel and in conjunction with an oxyfuel combustor, such as a gas generator 20. With this invention hydrogen is produced and separated and power generation additionally optionally occurs, with no atmospheric pollution or release of greenhouse gases (especially CO2) into the atmosphere.

In essence, and with particular reference to FIG. 2, basic details of a power generation and hydrogen production system are described according to a preferred embodiment. The system 10 utilizes a gas generator 20 which combusts a hydrogen and carbon containing fuel, such as methane, with oxygen. The gas generator is operated “fuel rich” so that the gas generator 20 produces products of combustion including hydrogen gas (typically molecular hydrogen, H2). The combustion products are then passed on to a hydrogen separator 30. The hydrogen separator uses one or more of various hydrogen separation technologies to separate the hydrogen in the combustion products from other constituents within the combustion products.

A second gas generator 40, also referred to as a reheater, receives the remaining products of combustion. The gas generator 40 is also fed with a supply of oxygen and is adapted to combust the remaining products of combustion with oxygen. This second gas generator 40 preferably combusts the oxygen with the remaining products of combustion at a stoichiometric ratio for the production of substantially only water and carbon dioxide. The water and carbon dioxide are then fed to a turbine 50 where the products of combustion are expanded and power is outputted through an electric generator 60.

The steam and carbon dioxide are then discharged and passed on to a separator 70, such as in the form of a condenser. Liquid condensed within the separator 70 is substantially pure water which can be routed back to the gas generator 20 or second gas generator 40 to manage combustion temperature within the gas generator 20 and gas generator 40, or the water can be discharged from the system. Gases separated within the separator 70 are primarily carbon dioxide. This carbon dioxide stream can be passed on to a carbon dioxide delivery site 80 in the form of an enhanced oil recovery site, a sequestration well directed into a terrestrial formation where carbon dioxide and/or other remaining gaseous constituents of the products of combustion can be sequestered, or can be provided for other disposal of the carbon dioxide such as commercial sale of the carbon dioxide for various purposes.

The overall system 10 optionally includes a bypass line 90 so that the hydrogen separator and optionally the second gas generator 40 can be bypassed when desired. For instance, the system 10 can be operated with the gas generator 20 combusting the fuel with the oxygen at a stoichiometric ratio when a maximum of electric power is to be outputted from the system 10. No hydrogen is produced and products of combustion from the gas generator 20, including substantially only water and carbon dioxide are passed to the turbine 50 to generate maximum power. When electric power generation is less desirable, such as during periods of off peak electric demand, the gas generator 20 can be operated in a fuel rich mode or other non-stoichiometric mode to maximize production of hydrogen separate from water in the products of combustion discharged from the gas generator 20. The bypass line 90 is then not used and the hydrogen separator 30 is used to separate the hydrogen from the other products of combustion.

More specifically, and with particular reference to FIG. 1, a basic initial embodiment of this invention is described. In this embodiment, the system 100 is defined in a mode where power production is not strictly required. Rather, the system could be simplified to only produce hydrogen from a hydrogen and carbon containing fuel. A gas generator is utilized such as that described in detail in U.S. Pat. No. 5,956,937, incorporated herein by reference in its entirety; and U.S. Pat. No. 6,206,684, incorporated herein by reference in its entirety.

The gas generator is configured to combust a hydrogen containing and carbon containing fuel with oxygen, rather than with air. Such a combustor is generally referred to as an oxyfuel combustor. Typically, water is also inputted into the gas generator to control a temperature of the combustion reaction within the gas generator. The water combines with products of combustion within the gas generator to be discharged from the gas generator as combustion products.

While the gas generator described in the above-identified patents specifies a stoichiometric ratio for the fuel and the oxygen to produce products of combustion including only carbon dioxide and water, with this invention such a stoichiometric ratio is modified. In particular, the fuel and oxygen ratio is modified, typically to be fuel rich, or to other ratios which cause other chemical compounds to result and be discharged as products of combustion from the gas generator. The inventors have experimented with one such oxyfuel combustor gas generator and have verified that operating the gas generator fuel rich produces quantities of hydrogen comprising over fifty percent of the products of combustion discharged from the gas generator.

When the gas generator is operated fuel rich, other products of combustion typically include carbon monoxide, carbon dioxide and water. While the water molecule also includes hydrogen therein, reference in this application to hydrogen is exclusive of that hydrogen contained within the water molecule, but rather is limited to molecular hydrogen (H2) or in some cases free hydrogen atoms which may not have yet formed molecular hydrogen, either due to the relatively high temperature involved or other characteristics of the flow of the combustion products being discharged from the gas generator.

With this simple embodiment of FIG. 1, the products of combustion discharged from the gas generator can be generally referred to as syngas, and are then passed to a hydrogen separator. Due to the small size of the hydrogen molecule (or free hydrogen) compared to the relative size of other molecules in the syngas, and other unique physical and chemical characteristics of hydrogen, a variety of different hydrogen separation techniques are available for efficient separation of the hydrogen from the other constituents within the syngas products of combustion from the gas generator. These techniques could include membrane separation, such as that described in U.S. Pat. No. 6,761,929, incorporated herein by reference in its entirety, or pressure swing adsorption technology such as that described in U.S. Pat. No. 6,660,064, incorporated herein by reference in its entirety.

The remaining constituents of the syngas are then discharged from the hydrogen separator. As these remaining constituents typically include carbon monoxide and carbon dioxide, which might not be permissibly merely discharged from the system, further processing can occur including combustion of the carbon monoxide, various reforming reactions, or sequestration. If power is to be generated by combustion of the carbon monoxide, and possibly any remaining hydrogen gas in the combustion products, such combustion can advantageously occur in a second oxyfuel combustion gas generator where additional oxygen would be supplied at a stoichiometric ratio necessary to cause only water and carbon dioxide to be discharged from the gas generator.

These simplified products of combustion can be easily separated in a condenser, or otherwise, so that a pure carbon dioxide stream can be provided for enhanced oil recovery or other sequestration within a terrestrial formation or be made available for commercial sale. If power is to be generated, the products of combustion would typically be fed to a turbine. This turbine (or other expander) could be located either upstream of the hydrogen separator with the hydrogen and the products of combustion also generating power through the turbine, or be located downstream of the hydrogen separator, and typically downstream of any second gas generator operating stoichiometrically, where only steam and carbon dioxide would pass through the turbine. As another alternative, multiple turbines could be provided at each of these locations or other locations within an overall power generation system.

With particular reference to FIG. 2, a particular detailed power generation system 10 is described which also features hydrogen separation. With this particular preferred power generation system, a gas generator 20 is provided as described in detail above. A water inlet 22, oxygen inlet 24 and fuel inlet 26 are each provided into the gas generator 20 spaced from an outlet 28. The water inlet 22 is preferably coupled to a water recirculation line 76 downstream from a condenser 70 or other separator which separates water from carbon dioxide and any other gases (typically oxides of carbon and other gases resulting from impurities in the fuel or oxygen) discharged from the turbine 50 or otherwise upstream from the condenser 70 or other separator. In this way, the system 10 does not require a separate water supply, but generates its own water. The water is not strictly necessary if the gas generator 20 is configured to handle the high temperatures associated with burning a hydrogen and carbon containing fuel with oxygen. However, typically water is required to maintain temperatures within the limits of available materials for manufacture of the gas generator 20.

The oxygen inlet 24 is typically coupled to a source of oxygen such as an air separation unit. Variations on acceptable air separation units include liquefaction systems, ion transfer membrane systems or pressure swing adsorption systems for separating oxygen from nitrogen in the air, such as described in particular in more detail in U.S. Pat. No. 5,956,937, incorporated herein by reference in its entirety.

The fuel inlet 26 is coupled to a supply of fuel which contains both hydrogen and carbon. One preferred fuel is methane (typically in the form of natural gas). Other fuels could include a standard syngas such as that produced by a gasifier of coal, biomass or other carbon, containing feed stocks. Where the fuel is such a syngas, it typically includes a mixture of hydrogen gas (H2) and carbon monoxide (CO). Other hydrocarbon fuels or fuels which are comprised of a mixture of hydrogen and carbon containing compounds could also be utilized as the fuel for combustion within the gas generator 20.

Importantly according to this invention, the fuel is not supplied to the gas generator 20 at a stoichiometric ratio for complete combustion with the oxygen. Rather, the fuel is provided at a non-stoichiometric ratio, and typically a fuel rich ratio. With such a ratio of supply into the gas generator 20, a significant amount of hydrogen is produced within the gas generator separate from the hydrogen contained within the water in the products of combustion of the gas generator 20. This hydrogen is typically molecular hydrogen (or possibly including free hydrogen, such as due to the high temperature within the gas generator 20 or lack of sufficient time for the hydrogen to form molecular hydrogen). In the case where the fuel is a syngas fuel, the hydrogen molecules are not produced within the gas generator 20, but merely pass through the gas generator 20 without all of the hydrogen in the fuel being combusted within the gas generator 20, but some of the hydrogen within the fuel passing through the gas generator 20 without combustion.

At the outlet 28, products of combustion leaving the gas generator 20 when the gas generator 20 is operating fuel rich typically include hydrogen, carbon monoxide, carbon dioxide and water. This mixture can be generally referred to as syngas. Preferably, a valve 29 is provided downstream from the gas generator 20 which can selectively feed either a hydrogen separator 30 or a bypass line 90. When the hydrogen is to be produced, the syngas is routed to the hydrogen separator 30 downstream from the gas generator 20. As an alternative, a turbine such as the turbine 50 or some other form of expander can be interposed between the gas generator 20 and the hydrogen separator 30 so that expansion of the syngas products of combustion from the gas generator 20 can occur before hydrogen separation at the hydrogen separator 30.

One factor in determining where to locate a turbine such as the turbine 50 within the system 10 is the desired temperatures and pressures for optimal separation of hydrogen within the hydrogen separator 30. Various different hydrogen separation technologies exist which require that the gas supplied into the hydrogen separator 30 be at various different temperatures and pressures. If the syngas products of combustion are at too high of a pressure or too high of a temperature at the outlet 28 of the gas generator 20, provision of a turbine or other expander upstream of the hydrogen separator 30 can both cause power to be generated and provide the syngas products of combustion at the optimal temperature and pressure for functioning within the hydrogen separator 30. It is also possible that multiple turbines or other expanders could be provided with one of the turbines between the gas generator 20 and the hydrogen separator 30 and second turbine 50 provided where shown in FIG. 2.

The hydrogen separator 30 includes an inlet 32 where the syngas products of combustion enter the hydrogen separator 30. A hydrogen outlet 34 is also provided where substantially pure hydrogen (or optionally less than completely pure hydrogen if a pure stream is not strictly required) is discharged from the system. A discharge 36 is also provided from the hydrogen separator 30 where remaining constituents of the syngas products of combustion are discharged from the hydrogen separator 30.

Various different hydrogen separation technologies can be utilized within the hydrogen separator 30. In general, if a large amount of hydrogen is contained within the syngas products of combustion discharged from the gas generator 20, it is typically most efficient and most beneficial to utilize pressure swing adsorption technology, such as that described in U.S. Pat. No. 6,660,064, incorporated herein by reference in its entirety. With such a system, the hydrogen product would be discharged from the hydrogen separator 30 at a high pressure. The remaining constituents of the syngas products of combustion discharged from the hydrogen separator at the discharge 36 would typically be at a lower pressure. Depending on the inlet pressures for the second gas generator 40 or inlet conditions required for whatever additional equipment is provided downstream from the hydrogen separator 30, a compressor may be required to recompress the remaining constituents discharged from the hydrogen separator 30. One condition where a relatively high percentage of hydrogen production occurs within the gas generator 20 is where the gas generator 20 is operated very fuel rich, such as with a fuel equivalence ratio of approximately 0.25. In such a configuration the product gas will have hydrogen production of over fifty percent.

At lower hydrogen production levels, it will likely make more economic and efficiency sense to remove most of the hydrogen from the syngas products of combustion with membrane separation technology, such as that described in U.S. Pat. No. 6,761,929, incorporated herein by reference in its entirety. With the utilization of such membrane technology, the hydrogen discharged from the hydrogen separator 30 would typically be at a lower pressure and may require recompression to some extent depending on the pressure requirements of a downstream storage facility or hydrogen distribution system fed by the hydrogen separator 30. However, the remaining constituents of the syngas products of combustion discharged from the hydrogen separator 30 from the discharge 36 would remain at a high pressure similar to that at the inlet 32, such that typically no recompression would be required upstream of the second gas generator 40 or other components provided downstream from the hydrogen separator 30.

In this preferred embodiment, the discharge 36 leads to a fuel inlet 46 for a second gas generator 40 (also referred to as a reheater). This second gas generator 40 preferably always operates at a stoichiometric ratio with the hydrogen depleted products of combustion entering the second gas generator 40 at a fuel inlet 46. The second gas generator 40 also includes an oxygen inlet 44 and preferably also a water inlet 42 spaced from an outlet 48 for the second gas generator 40.

The second gas generator 40 generally operates similar to the gas generator described in detail in U.S. Pat. Nos. 5,956,937 and 6,206,684, incorporated herein by reference in their entirety. With the gas generator 40 operating at a stoichiometric ratio of fuel to oxygen, the products of combustion discharged from the reheater outlet 48 are preferably substantially only water/steam and carbon dioxide. These products of combustion are then fed to the turbine 50 for expansion and power production. In particular, the turbine 50 includes an inflow 52 which receives the steam and carbon dioxide and an outflow 54 which discharges the mixture of steam and carbon dioxide. A power output 56 couples the turbine 50 to an electric generator 60 for power generation. This electric generator 60 or a separate electric generator 60 can also be coupled to other turbines located at other locations within the system 10 if desired.

The turbine 50 is depicted as a single turbine 50. However, multiple turbines 50 could be provided with various different inlet and outlet pressures and temperatures to optimize power generation. Also, further reheaters could be provided adjacent each other within the system, such as between the turbines, for efficiency optimization.

The turbine outflow 54 leads to a condenser 70 or other separator for separation of the water from carbon dioxide or other non-condensable gases (i.e. other oxides of carbon such as carbon monoxide or gases such as argon or gases resulting from fuel pollutants such as oxides of nitrogen or sulfur) remaining within the products of combustion passing through the turbine 50. Before entering the condenser/separator 70, it is conceivable that a separate hydrogen separator could be located, such as at point 58. Such a position for the hydrogen separator would be provided if the second gas generator 40 were also operated in a fuel rich or other non-stoichiometric configuration where additional hydrogen gas is produced or allowed to pass without combustion (or in systems where the second gas generator is omitted or bypassed).

In such an arrangement, other constituents within the products of combustion passing into the condenser 70 or other separator could be discharged as non-condensable gases from the condenser 70 or other separator along with the CO2 passing on to the CO2 handling site 80. For instance, if a relatively small amount of carbon monoxide is included with the carbon dioxide and the mixture of carbon monoxide and carbon dioxide are to be sequestered within a terrestrial formation, it may be acceptable to discharge the carbon monoxide in such a way (as well as small amounts of oxides of nitrogen or sulfur). Alternatively, the carbon monoxide could be reformed or otherwise combusted after separation from the carbon dioxide or before such further separation, to eliminate carbon monoxide and other pollutants from the system.

As another option, the hydrogen separator could be provided downstream from the condenser 70 or other separator with the hydrogen allowed to pass along with the CO2 out of the condenser 70 or other separator. In such a configuration, the hydrogen separator could utilize membrane technology or other technology for hydrogen removal from carbon dioxide and other non-condensable gases discharged from the condenser 70 or other separator.

The water which condenses within the condenser 70 or is otherwise discharged from the separator 70 passes out of the condenser 70 or other separator through a fluid outlet 74. A gaseous outlet 72 is provided separate from the fluid outlet 74. The oxides of carbon and other “non-condensable gases” discharged from the condenser 70 through the oxides of carbon outlet 72 would typically be compressed with a compressor to a pressure matching a pressure within a target terrestrial formation, such as an at least partially depleted oil well, to facilitate sequestration away from the atmosphere. The fluid outlet 74 leads to a water recirculation line 76 which optionally feeds a reheater branch 78 leading to the gas generator 40 and with the water recirculation line 76 also feeding the water inlet 22 of the gas generator 20. Excess water is typically also produced which can be discharged from the system as substantially pure water.

The bypass line 90 is particularly beneficial in that it allows the system 10 in this preferred embodiment to operate in two modes to optimize performance of the system 10. In a first mode, described in detail above, hydrogen production is maximized by keeping the bypass line 90 closed. In this first mode, hydrogen is produced and some electric power is generated. In the second mode, the bypass line 90 is utilized by opening the bypass valve 29. In a second mode, the gas generator 20 is also preferably operated with the fuel having a stoichiometric ratio with the oxygen. Thus, substantially only water and carbon dioxide are generated in the gas generator 20 and pass through the bypass line 90. This bypass line 90 can pass through a second valve 92 which either redirects the steam and carbon dioxide to the second gas generator 40 along path 94 (typically after first passing through a high pressure turbine) or can pass through the valve 92 and continue along the reheater bypass line 96 to bypass the second gas generator 40 and be directed directly to the turbine 50. Conceivably, the bypass line 90 could merely be through the hydrogen separator 30 but with no hydrogen present to be separated due to the stoichiometric combustion ratio in the gas generator associated with the second mode of operation.

In either event, electric power generation is maximized relative to the first mode of operation but no hydrogen is produced. One way to operate the system 10 would be to monitor the demand for electric power. When the demand for electric power is high, the system would be operated in the second mode to maximize electric power generation. When demand for electric power is relatively low, the power generation system would be operated in the first mode to maximize hydrogen production.

The hydrogen would be produced and stored or fed into a hydrogen distribution system. In this way, the overall system 10 would operate at a maximum capacity on a more continuous basis, perhaps increasing the economics with which the overall system 10 would be operated.

This disclosure is provided to reveal a preferred embodiment of the invention and a best mode for practicing the invention. Having thus described the invention in this way, it should be apparent that various different modifications can be made to the preferred embodiment without departing from the scope and spirit of this invention disclosure. When structures are identified as a means to perform a function, the identification is intended to include all structures which can perform the function specified. When structures of this invention are identified as being coupled together, such language should be interpreted broadly to include the structures being coupled directly together or coupled together through intervening structures. Such coupling could be permanent or temporary and either in a rigid fashion or in a fashion which allows pivoting, sliding or other relative motion while still providing some form of attachment, unless specifically restricted.

What is claimed is:

1: A power generation system featuring hydrogen production and power production, comprising in combination:
a gas generator having a fuel inlet and an oxygen inlet upstream from an outlet;
said fuel inlet coupled to a source of fuel, the fuel including hydrogen and carbon;
said gas generator adapted to combust the fuel and oxygen non-stoichiometrically, with at least some of the hydrogen exiting said gas generator through said outlet in a form other than within a water molecule;
a hydrogen separator having an inlet, a hydrogen outlet and a discharge, said inlet downstream from said gas generator outlet;
said hydrogen separator adapted to separate at least a portion of hydrogen from other constituents exiting said gas generator through said gas generator outlet and direct the separated hydrogen to said hydrogen outlet;
an expander having an inflow downstream from said outlet of said gas generator, an outflow and a power output; and
said expander adapted to expand the constituents entering said inflow and provide power through said power outlet.

2: The system of claim 1 wherein a reheat gas generator is provided with a fuel inlet downstream from said discharge of said hydrogen separator, an oxygen inlet, and a reheater outlet; and
said reheat gas generator adapted to combust at least a portion of the constituents exiting said hydrogen separator at said discharge, said reheater outlet upstream of said expander inflow.

3: The system of claim 1 wherein said gas generator includes a water input, said gas generator adapted to bring water from said water input into direct contact with products of combustion generated within said gas generator.

4: The system of claim 3 wherein a separator is located downstream from said outflow of said expander, said separator adapted to separate at least a portion of water exiting said expander through said outflow from oxides of carbon exiting said expander through said outflow.

5: The system of claim 4 wherein a water recirculation pathway is interposed between a water outlet of said separator and said water input into said gas generator.

6: The system of claim 5 wherein a reheat gas generator is provided with a fuel inlet downstream from said discharge of said hydrogen separator, an oxygen inlet, and a reheater outlet;
said reheat gas generator adapted to combust at least a portion of the constituents exiting said hydrogen separator at said discharge, said reheater outlet upstream of said expander inflow; and
wherein said reheat gas generator includes a water input coupled to said water outlet of said separator.

7: The system of claim 4 wherein at least one compressor is coupled to said separator downstream from said oxides of carbon outlet, said at least one compressor adapted to compress the oxides of carbon to a pressure at least as great as a pressure within a terrestrial formation into which the oxides of carbon can be sequestered away from the atmosphere.

8: The system of claim 7 wherein said terrestrial formation is an at least partially depleted oil well.

9: The system of claim 1 wherein said expander includes a turbine and said power output includes an electric generator coupled to said turbine.

10: The system of claim 1 wherein said hydrogen separator includes at least one membrane, said membrane adapted to more easily allow hydrogen molecules to pass therethrough than oxides of carbon.

11: The system of claim 1 wherein said hydrogen separator includes a pressure swing adsorption system.

12: The system of claim 1 wherein said gas generator is adapted to operate fuel rich.

13: The system of claim 12 wherein said fuel includes methane with products of combustion created within said gas generator including hydrogen, carbon monoxide, carbon dioxide and water.

14: The system of claim 12 wherein said fuel includes a syngas comprised of molecular hydrogen and carbon monoxide with products of combustion created within said gas generator including hydrogen, carbon monoxide, carbon dioxide and water.

15: The system of claim 14 wherein said source of fuel is downstream from a gasifier, said gasifier including an inlet for carbon containing fuel, an oxygen inlet and a water inlet, the gasifier adapted to produce a syngas including hydrogen and carbon monoxide.

16: The system of claim 15 wherein said carbon containing fuel includes coal.

17: The system of claim 15 wherein said carbon containing fuel includes biomass fuel.

18: The system of claim 1 wherein said oxygen inlet is coupled to an oxygen outlet of an air separation unit, said air separation unit adapted to separate oxygen from air.

19: A method for combustion based power generation with hydrogen production, the method including the steps of:
combusting a non-stoichiometric mixture of oxygen with a fuel containing hydrogen and carbon;
generating products of combustion including hydrogen not bonded to oxygen in a water molecule and at least one oxide of carbon;
separating the hydrogen in the products of combustion of said generating step from other products of combustion; and
expanding the products of combustion to generate power.

20: The method of claim 19 wherein said separating step occurs after said expanding step with said expanding step also expanding the hydrogen while still mixed with the products of combustion.

21: The method of claim 19 wherein said separating step occurs before said expanding step.

22: The method of claim 21 including the additional step of further combusting products of combustion with oxygen after said separating step and before said expanding step, said further combusting step at least partially reducing an amount of carbon monoxide contained within the products of combustion.

23: The method of claim 22 wherein said generating step produces water along with oxides of carbon and hydrogen not bonded to oxygen in a water molecule; and
separating the water from the oxides of carbon.

24: The method of claim 23 wherein said water and oxides of carbon separating step includes the step of condensing water within the products of combustion while allowing oxides of carbon within the products of combustion to remain gaseous.

25: The method of claim 23 including the further step of recirculating at least a portion of water after said water and oxides of carbon separating step, the recirculated water routed back to a gas generator in which said combusting step is performed.

26: The method of claim 23 including the further step of sequestering oxides of carbon separated by said water and oxides of carbon separating step within a terrestrial formation separate from the atmosphere.

27: The method of claim 26 wherein said terrestrial formation includes an at least partially depleted oil well.

28: The method of claim 19 wherein said separating step includes the step of interposing a membrane adjacent products of combustion of said generating step with the membrane more readily allowing hydrogen to pass therethrough than other products of combustion.

29: The method of claim 19 wherein said separating step includes the step of utilizing a pressure swing adsorption system to separate hydrogen from the other products of combustion.

30: The method of claim 19 wherein said combusting step includes the step of maintaining a fuel rich mixture of fuel to oxygen.

31: A system for production of hydrogen from a hydrocarbon, comprising in combination:
a gas generator having a fuel inlet and an oxygen inlet upstream from an outlet;
said fuel inlet coupled to a source of fuel;
said gas generator adapted to combust the fuel and oxygen non-stoichiometrically, with at least some of the hydrogen exiting said gas generator through said outlet in a form other than within a water molecule;
a hydrogen separator having an inlet, a hydrogen outlet and a discharge, said inlet downstream from said gas generator outlet; and
said hydrogen separator adapted to separate at least a portion of hydrogen from other constituents exiting said gas generator through said gas generator outlet and direct the separated hydrogen to said hydrogen outlet.

32: The system of claim 31 wherein an expander is provided having an inflow located downstream form said outlet of said gas generator and an outflow and a power output, said expander adapted to expand constituents entering said inflow and provide power through said power outlet.

33: The system of claim 32 wherein said expander inflow is located downstream from said hydrogen separator discharge and a reheater is interposed between said expander inflow and said discharge, said reheater having a fuel inlet downstream from said hydrogen separator discharge, an oxygen inlet and an outlet upstream of said expander inflow.

34: The system of claim 33 wherein a bypass line is provided with an intake interposed between said gas generator outlet and said hydrogen separator inlet and a bypass outlet interposed between said discharge of said hydrogen separator and said inflow of said expander, said bypass adapted to selectively bypass at least a portion of products of combustion of said gas generator around said hydrogen separator.

35: The system of claim 33 wherein said gas generator is adapted to be adjusted between a stoichiometric mode where fuel and oxygen are combusted stoichiometrically and a non-stoichiometric mode where fuel and oxygen are combusted non-stoichiometrically.
